(19) United States
(12) Patent Application Publication
(10) Pub. No.: US 2012/0049415 A1
(43) Pub. Date: Mar. 1, 2012

(54) METHODS AND APPARATUS FOR DRYING LOGS WITH MICROWAVES USING FEEDBACK AND FEED FORWARD CONTROL

(76) Inventors: Jacob George, Horseheads, NY (US); Parasuram Padmanabhan Harihara, Painted Post, NY (US); Min Shen, Horseheads, NY (US)

(21) Appl. No.: 12/870,282

(22) Filed: Aug. 27, 2010

(51) Int. Cl. H05B 6/68

(52) U.S. Cl. 264/432; 425/143

(57) ABSTRACT

Methods and apparatus for microwave drying of green cellular ceramic bodies (logs) using feedback and feed forward control are disclosed. The methods include measuring an amount of dissipated microwave power and measuring temperatures of the logs and inputting this information into a drying model. The drying model accounts for at least a heat capacitance, a water content and a mass of the logs, and relates changes in the dissipated microwave power to changes in the log temperature. The changes in microwave power generated by the adjustable microwave source are thus based on the calculated dissipated power changes.

### BACKGROUND

1. Field

The present disclosure relates generally to methods and apparatus for manufacturing ceramic materials, and more particularly to methods and apparatus for heating and drying logs with microwaves using feedback and feed forward control.

2. Technical Background

Conventional heating or drying comprising convectional or a combination of convectional and radiative gas or electric resistance heating is commonly used in the manufacture of ceramic materials to remove moisture from green cellular ceramic bodies (logs). However, the heating rate, temperature control and application of heat associated with these conventional heating methods often results in high energy consumption and inconsistent product quality.

Industrial heating by microwave radiation has been used to accelerate log drying. In comparison with conventional heating, microwave heating provides a higher heating rate and is generally faster than conventional drying because the log is heated directly through the interaction of the microwave energy with the log. A single microwave applicator or a plurality of microwave applicators can be employed to heat and dry the logs.

However, while heating and drying logs, the application of microwave energy offers advantages over other heating and drying methods, microwave heating and drying systems currently used also have several drawbacks. For example, changes in the system or upstream process can cause short term variability and long term drift in the final log temperatures if the microwave power is not controlled appropriately.

### SUMMARY

An aspect of the disclosure is a control method of microwave drying green cellular ceramic bodies using an adjustable microwave source operably coupled to a microwave chamber. The method includes passing the green cellular ceramic bodies through the microwave chamber to expose them to microwave radiation having a microwave power generated by the microwave source. The method also includes periodically measuring an amount of dissipated microwave power and generating first signals representative thereof. The method further includes periodically measuring temperatures of the green cellular ceramic bodies and generating second signals representative thereof. The method additionally includes inputting the first and second signals into a drying model that accounts for at least a heat capacitance, a water content and a mass of the green cellular ceramic bodies, and that relates a change in the dissipated microwave power to a change in the green cellular ceramic body temperature. The method then includes calculating, using the drying model, a change in the amount of dissipated power due to changes in the green cellular ceramic bodies based on the measured temperature changes and the measured dissipated microwave power. The method finally includes adjusting the amount of microwave power generated by the adjustable microwave source by the calculated amount of dissipated power.

Another aspect of the disclosure is a microwave drying system with a feedback and feed forward control for drying green cellular ceramic bodies. The system includes a microwave chamber having an interior through which the green cellular ceramic bodies are conveyed from an entrance to an exit. An adjustable microwave source is operably coupled to the microwave chamber and is configured to generate microwave radiation having an amount of microwave power within the microwave interior. First and second detectors are respectively arranged to measure transmitted and reflected microwave power and generate respective first and second signals representative thereof. At least one temperature sensor is arranged to periodically measure temperatures of the green cellular ceramic bodies and generate third signals representative thereof. A programmable controller is configured with a drying model that performs a calculation of a change in the amount of dissipated power due to changes in the temperature of the green cellular ceramic bodies based on the measured temperature changes and the measured dissipated microwave power, wherein the drying model accounts for at least a heat capacitance, a water content and a mass of the green cellular ceramic bodies. The controller is further configured to provide a control signal to the microwave source to adjust the amount of microwave power provided to the microwave cavity based on the calculated change in the amount of dissipated power.

Another aspect of the disclosure is a control method of drying green cellular ceramic bodies in a drying process. The method includes conveying the green cellular ceramic bodies through a microwave chamber having an interior and an exit end, and providing an amount of microwave power to the microwave chamber interior. The method also includes measuring an amount of microwave power dissipated by the microwave chamber interior and the green cellular ceramic bodies travelling therethrough. The method further includes measuring initial temperatures of the green cellular ceramic bodies during the drying process, and measuring final temperatures of the green cellular ceramic bodies at or adjacent the exit end at an end of the drying process. The method also includes adjusting the amount of microwave power provided to the chamber based on a drying model for the green cellular ceramic bodies that accounts for at least a heat capacitance, a water content and a mass of the green cellular ceramic bodies, and that relates a change in the measured dissipated microwave power to a change in the green cellular ceramic body temperature as determined from the measured final temperatures.

Additional features and advantages of the disclosure are set forth in the detailed description below, and in part will be readily apparent to those skilled in the art from that description or recognized by practicing the disclosure as described herein, including the detailed description that follows, the claims, and the appended drawings.

It is to be understood that both the foregoing general description and the following detailed description present embodiments of the disclosure, and are intended to provide an overview or framework for understanding the nature and character of the disclosure as it is claimed. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

FIG. 1A is a generalized schematic diagram of an example microwave dryer for heating green cellular ceramic bodies;

FIG. 1B is similar to FIG. 1A and shows an example embodiment where the microwave dryer assembly includes multiple dryers each having one or more applicators;

FIG. 2 is a more detailed schematic diagram of an example microwave dryer based on the generalized embodiment of FIG. 1;

FIG. 3 is a plot of temperature (° C.) vs. processing time (seconds), showing a measured average temperature difference of about 10° C. for a log mass difference of about 9.2% between two logs samples;

FIG. 4 shows an example chart that plots the measured final log temperature (° C.) versus log sample number, wherein the data in the chart are taken from actual production data;

FIG. 5 is similar to FIG. 4 and shows a control chart wherein the microwave dryer system utilized long-term temperature shifts as feedback to the microwave source to adjust the amount of microwave energy provided to chamber interior based on updates in the required dissipated power provided to the controller;

FIG. 6 is a schematic diagram of an example controller configuration shown in connection with some of the relevant components of the microwave dryer system;

FIG. 7 is a schematic diagram of an example controller configuration that receives an error signal Se representative of the error between the expected dissipated power and the measured dissipated power, and outputs a signal SC4 representative of a change in magnetron power ΔP_{mag}, and where an electrical signal SP(tₖ₋₁) representative of a previous control action P(tₖ₋₁) is added to the change in magnetron power to form a combined signal SCC;

FIG. 8 is similar to FIG. 7, and illustrates an example controller configuration that additionally includes an output power ramp rate signal SPRR;

FIG. 9 sets a plot of equation (11) of the power ramp rate as a function of the change in magnetron power ΔP_{mag} with K₃=1;

FIG. 10 is similar to FIG. 8 and illustrates an example controller configuration where the power ramp rate controller unit receives a tray inch signal from the dissipated power controller;

FIG. 11 is similar to FIG. 6 and illustrates an example microwave dryer system based on an example feed-forward controller configuration used in conjunction with feedback control to counteract short and long-term drying process changes.

### DETAILED DESCRIPTION

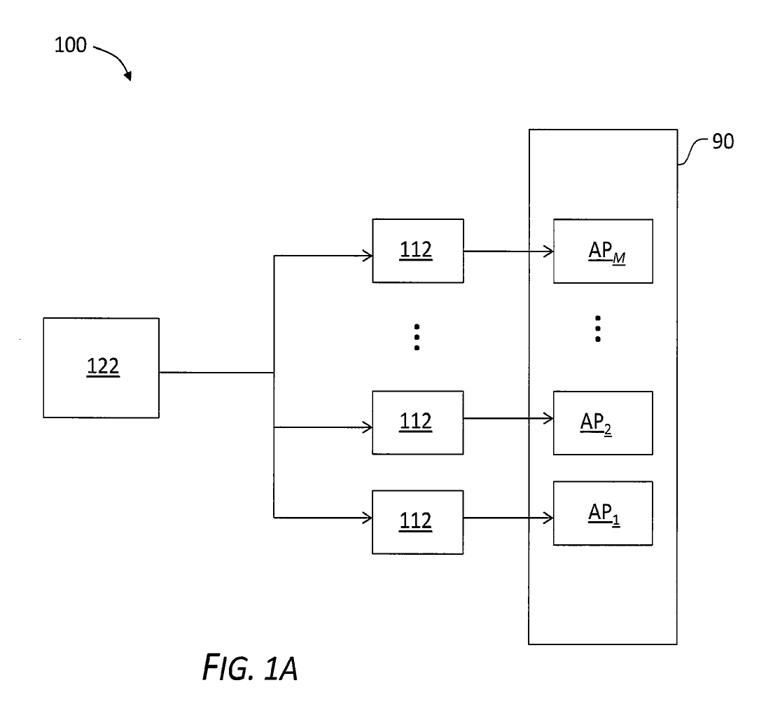

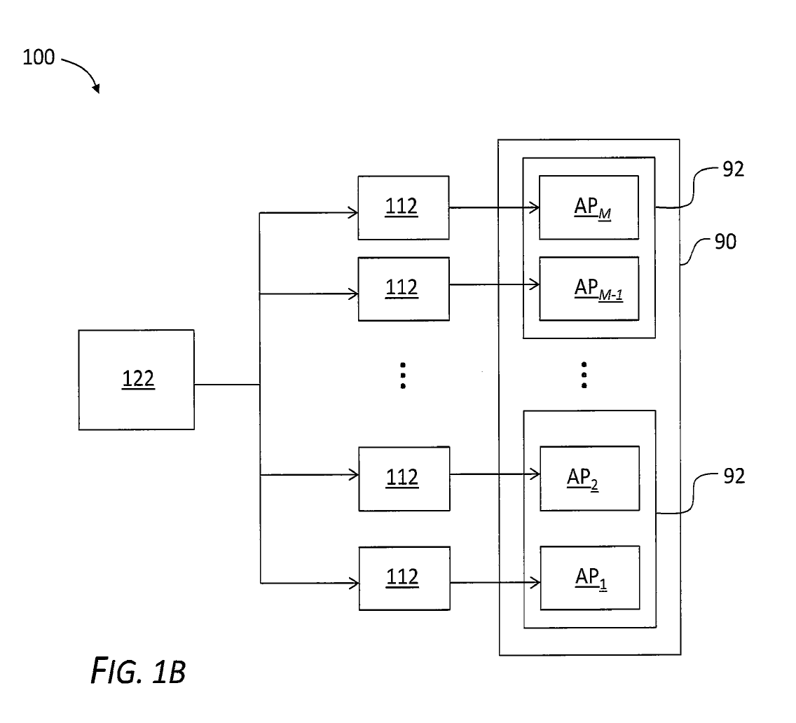

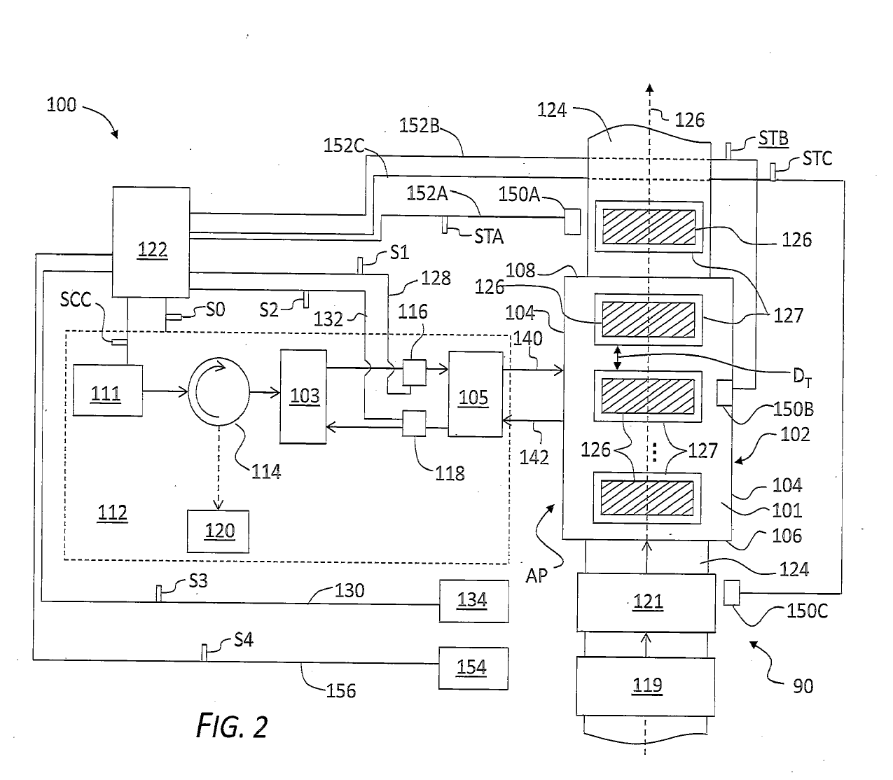

Reference is now made in detail to FIG. 1A and FIG. 1B that show a generalized example of a microwave dryer system 100, and to FIG. 2 that shows a more detailed example of the microwave dryer system for heating green cellular ceramic bodies 126 according to the methods and example embodiments described herein. With reference to FIG. 1A, microwave dryer system 100 includes a microwave dryer assembly 90 that includes one or more (e.g., a total of M) applicators AP₁, AP₂, . . . AP_{M}, M microwave sources 112 operably coupled to the M microwave applicators in the microwave dryer assembly, and a controller 122 operably coupled to the microwave sources and to one or more components of the microwave dryer assembly.

As discussed below, controller 122 may include multiple controller units arranged in various locations in and about microwave dryer system 100, and a single controller is shown in FIG. 1 and FIG. 2 for the sake of illustration and generality. Likewise, in FIG. 2, microwave dryer assembly 90 is shown as having a single applicator AP and a single microwave source 112. The various elements of microwave dryer 100, configurations for controller 122 and the associated methods for heating and drying green cellular ceramic bodies are discussed in further detail herein. Whenever possible, the same reference numerals and symbols will be used throughout the drawings to refer to the same or like parts. U.S. Patent Application Publications No. 2010/0107435 (the '435 publication) and 2010/0108667 (the '667 publication) are incorporated by reference herein.

FIG. 1B is similar to FIG. 1A, and illustrates an example embodiment where microwave dryer assembly 90 includes multiple dryers 92 that each include one or more applicators AP. Microwave dryer assembly 90 may also include a single dryer 92 with one or more applicators AP.

As illustrated in FIG. 2, microwave dryer assembly 90 includes a microwave heating chamber 102 having a chamber interior 101. Microwave heating chamber 102 generally comprises sidewalls 104, an entrance 106, an exit 108, and a top and bottom (not shown). In one embodiment, the sidewalls 104 and the top and bottom are formed from a microwave-impermeable, non-magnetic material that may exhibit a high electrical conductivity and resistance to oxidation at temperatures in the range of 200° C. Each of the top and bottom and sidewalls 104 of the microwave heating chamber 102 may comprise an inner shell and an outer shell with a layer of insulation (e.g., fiberglass or a comparable insulating material) disposed therebetween.

Microwave heating chamber 102 is configured such that green cellular ceramic bodies 126 (hereinafter “logs”) carried by dielectric trays 127 pass continuously through the chamber interior 101 along a flow axis AF in the direction of the arrow. Flow axis AF approximates the path of logs 126 through chamber interior 101, such as when microwave dryer system 100 is a continuous throughput system. The entrance 106 and exit 108 of microwave heating chamber 102 are equipped with shielding to reduce radiation leakage from the microwave heating chamber while still permitting the flow of logs 126 into and out of the chamber.

In an example embodiment, microwave dryer assembly 90 includes adjacent input end 106 an extruder 119 configured to extrude relatively large ceramic logs (not shown), and a wet saw 121 that receives the larger extruded ceramic logs and cuts them into the shorter logs 126.

In one embodiment, microwave heating chamber 102 is multimodal and thus supports a large number of resonant modes in a given microwave frequency range. In another embodiment, microwave heating chamber 102 includes a mode stirrer (not shown) to provide a relatively uniform electric field distribution within chamber interior 101. Microwave heating chamber 102 operably supports one or more applicators AP (FIG. 1A and FIG. 1B).

To facilitate continuous throughput, microwave dryer assembly 90 includes a transport system 124 for transporting logs 126 through chamber interior 101. Transport system 124 extends through chamber interior 101 from entrance 106 to exit 108. In one embodiment, transport system 124 comprises a conveyor, such as a belt conveyor or a chain-linke conveyor, on which logs 126 supported by trays 127 is positioned. However, it should be understood that transport system 124 may comprise any suitable system for conveying ceramic bodies through chamber interior 101 from entrance 106 to exit 108. Accordingly, no particular limitation is intended as to the type of transport system used to convey the logs through microwave heating chamber 102.

Microwave source 112 is operatively coupled to microwave heating chamber 102 and is configured to direct microwave radiation having a microwave power into chamber interior 101. In one embodiment, microwave source 112 is operatively coupled to microwave heating chamber 102 with a microwave transmission line that includes in one example waveguide 103, and a tuner 105 with waveguide and/or leaky waveguide coupling (not shown) to microwave heating chamber 102, as shown in FIG. 2. Microwave source 112 includes a microwave generator 111 that in an example is adjustable with respect to microwave power and/or frequency.

In one embodiment, microwave generator 111 comprises a conventional magnetron with an adjustable power feature. The frequency of the generated microwave energy is greater than about 900 MHz (0.9 GHz). In one embodiment, the frequency of the microwave energy generated by microwave generator 111 is from about 10 MHz to about 100 GHz, and, more particularly, frequencies from about 800 MHz to about 6 GHz, which generally includes three of the industrial, scientific and medical microwave bands in the United States. In other countries, other microwave frequencies are utilized, such as in the range from about 10 MHz to about 100,000 MHz. In practice, the power of the generated microwave energy is no greater than that required to raise the temperature of logs 126 in the chamber interior 101 to a temperature effective for drying the logs.

Generally, microwave generator is operable to vary the power of the microwaves emitted by microwave source 112 up to about 200 kW. For example, microwave generator 111 is capable of generating microwave energy having a power of about 0 kW to about 100 kW with a frequency of about 915 MHz. Magnetrons of this type may generate microwave energy sufficient to rapidly raise the temperature within a given log 126 to a drying temperature in as little as 1 to 5 minutes depending on several factors including, without limitation, the load (e.g., the total mass of the logs in the microwave heating chamber, including the mass of moisture in the log), the geometrical configuration of the logs, the compositions of the logs, the relative positioning of the logs, and the rate at which the logs pass through the microwave heating chamber, and so on.

As shown in FIG. 2, an example microwave source 112 includes a circulator 114 disposed between microwave generator 111 and microwave heating chamber 102. In one example, microwave energy transmitted from microwave source 111 to microwave heating chamber 102 (e.g., the transmitted microwave energy 140) passes through circulator 114, through waveguide 103 and tuner 105, and into chamber interior 101 through waveguides and/or leaky waveguides. Microwave energy 142 is also reflected from microwave heating chamber 102 back toward microwave generator 111. The reflected microwave energy 142 is diverted by circulator 114 into a dissipating load 120 operatively connected to the circulator, thereby preventing damage to the microwave generator.

To facilitate control of microwave source 112, microwave generator 111 is electrically coupled to controller 122. Controller 122 is operable to vary the power and frequency of the microwave energy generated by the microwave generator 111 and thus microwave source 112. In one embodiment, controller 122 is operable to send electrical control signals SCC to the microwave generator 111 to vary the power and/or frequency of the microwave energy 122 generated by the microwave source 112, as discussed in greater detail below. Controller 122 may also be operable to receive signals S0 from the microwave source 112 indicative of the power and/or frequency of the microwave energy being generated by the microwave source.

The portion of the transmitted microwave energy 140 that is not dissipated in chamber interior 101 is reflected back towards microwave generator 111 as reflected microwave energy 142. Variability in the microwave energy dissipated by microwave heating chamber 102 leads to temperature variations between logs heated with the same amount of transmitted microwave power. These temperature variations reduce the capability of the microwave dryer system 100 and may also lead to under-drying of the logs (e.g., “cold log” conditions) or over-drying of the logs (e.g., “hot log” conditions), either of which may adversely impact the throughput of the microwave dryer system 100 and the ceramic manufacturing process in which the microwave dryer is incorporated, including adversely affecting the quality of the final ceramic product.

With continued reference to FIG. 2, in an example, a transmitted power sensor 116 is disposed between microwave generator 111 and microwave heating chamber 102 and is operable to measure the power (amount) of the transmitted microwave energy 140. Likewise, a reflected power sensor 118 is disposed between microwave heating chamber 102 and microwave generator 111, and in one example is disposed between the microwave heating chamber 102 and the circulator 114 (e.g., between waveguide 103 and tuner 105), and is operable to measure the power (amount) of the reflected microwave energy 142. In one embodiment, the transmitted power sensor 116 and the reflected power sensor 118 may each comprise a microwave power sensor having an error of about ±5%. For example, a suitable power sensor for use as power sensors 116 and 118 includes the E9300A E-series power sensor manufactured by Agilent Technologies, which has an error accuracy of less than ±0.5%. However, it should be understood that any power sensor having a similar accuracy may also be used.

Transmitted power sensor 116 is electrically coupled to controller 122 via electrical lead 128 and generates and sends to the controller electrical signals S1 representative of the amount of power of transmitted microwave energy 140. Similarly, reflected power sensor 118 is electrically coupled to controller 122 via electric lead 132 and generates and sends to the controller 122 electrical signals S2 representative of the amount of power of reflected microwave energy 142.

In one embodiment, as shown in FIG. 2, controller 122 is electrically coupled to an input device 134 via an electrical lead 130. The input device 134 is operable to generate and send electrical signals S3 to controller 122 representative of the load or total weight or mass of logs 126 positioned in microwave heating chamber 102. The weight or mass of logs 126, as used herein, refers to the weight of the ceramic material making up the log, as well as the weight of any liquid contained by log including, without limitation, water and/or any solvents or other processing agents introduced into the ceramic material during the formation of the log. In one embodiment, input device 134 is or includes a keyboard or keypad operably connected to controller 122 such that an operator of microwave dryer system 100 may manually enter the weight of a log entering microwave heating chamber 102. The weight of logs 126 is determined by periodically removing a log from transport system 124 and weighing the log prior to the log entering the microwave heating chamber 102. The measured weight of the log is then entered into input device 134 and the information passed to controller 122 via electrical signals S3.

In another embodiment, input device 134 includes a scale or other measurement device positioned along transport system 124 and is operable to weigh each log 126 as the logs enter microwave heating chamber 102. In this way, the total weight of logs 126 in the chamber interior 101 is known at any one time. For example, as shown in FIG. 2, a detector 154, such as an optical detector, an ultrasonic detector, or the like, is positioned proximate transport system 124 and is operatively coupled to controller 122 with an electric lead 156. In one example, detector 154 is operable to determine the number of logs 126 present in chamber interior 101, including the number of fractional number of logs, by detecting the logs as they are transported on transport system 124. Detector 154 is adapted to generate and send an electrical signal S4, which in one example is representative of the number of logs. Based on this information, controller 122 is operable to determine the total weight of logs in chamber interior 101 at any one time. In another example, detector 154 is operable, in combination with controller 122, to determine tray spacings (distances) D_{T} between adjacent trays 127 by information embodied in electrical signals S4.

In an example embodiment, microwave dryer system 100 includes at least one temperature sensor 150 (such as a pyrometer, infra-red or a fiber optic temperature sensor) positioned proximate the transport system 124 and operatively coupled to controller 122 with an electric lead 152. In the example shown in FIG. 2, three temperature sensors 150A, 150B and 150C are shown that are respectively connected to controller 122 via leads 152A, 152B and 152C. Temperature sensor 150A is operable to determine the temperatures of logs 126 as they exit microwave heating chamber 102 at exit 108 and convey this information (i.e., the final log temperature T_{F}) to the controller 122 via temperature signals STA. Likewise, temperature sensor 150B is operable to determine the temperatures of logs 126 while they are within chamber interior 101 and convey this information (i.e., a measurement of the intermediate temperature T_{INT}) to the controller 122 via temperature signals STB. Temperature sensor 150C is operable to determine the temperatures of logs 126 as they enter the microwave heating chamber 102 and convey this information (i.e., a measurement of the initial log temperature T_{INIT}) to the controller 122 via temperature signals STC.

The controller 122 may use the temperature data from the one or more temperature signals ST (e.g., signal STA from temperature sensor 150A, signal STB from temperature sensor 150B and signal STC from temperature sensor STC) to determine the amount of heating (e.g., the amount of microwave energy that needs to be applied) such that logs 126 have a desired moisture content upon exiting the microwave heating chamber 102. Also, as discussed below, one or more of temperature signals ST is used to provide feed-forward control to controller 122 to control the amount of microwave energy provided to microwave heating chamber 102 by microwave source 112.

In yet another embodiment, input device 134 is operable to send controller 122 electrical signals S3 indicative of at least one of the number, weight, geometrical configuration and material composition of logs 126 within chamber interior 101. These log parameters are, in one embodiment, manually inputted into input device 134. In this particular embodiment, controller 122 is operable to process electrical signals S3 received from input device 134 and, using these signals, adjusts the power and/or frequency of the microwave energy generated by microwave source 112. For example, when the geometrical configuration and material composition of logs 126 are entered into input device 134, controller 122 increases or decreases the power of the microwave energy generated by the microwave source according the particular controller programming, configuration and input signals, examples of which are discussed below.

In an example, controller 122 is programmed to vary the power and/or frequency of microwave energy generated by microwave source 112 based on electrical (input) signals S1, S2, S3, S4 and ST (e.g., signals STA, STB and STC) respectively received from transmitted power sensor 116, reflected power sensor 118, input device 134, detector 154, and at least one temperature sensor 150 (e.g., temperature sensors 150A, 150B and 150C). For example, in operation, one or more logs 126 are placed on transport system 124 such that the logs are conveyed into entrance 106 of the microwave heating chamber 102. In an example, controller 122 is programmed to adjust the microwave energy generated by microwave source 112 and transmitted into chamber interior 101 such that logs 126 passing through the interior are heated to a predetermined or desired temperature T_{D}. For example, microwave dryer system 100 is operable to preheat, evaporatively heat or post-heat logs 126 in microwave heating chamber 102. As used herein, preheat or preheating refers to heating logs 126 without substantial evaporation of the liquid within the logs. Evaporatively heat or evaporative heating, as used herein, refers to heating and maintaining logs 126 at a temperature such that the moisture inside the log is evaporated and thereby removed from the log. Post-heat or post-heating, as used herein, refers to heating the logs to temperatures over the evaporative temperature of water to further remove any liquid from the ceramic green bodies. The operating conditions of microwave dryer system 100 are adjusted using controller 122 to achieve the necessary temperatures for heating (e.g. preheating, evaporatively heating, and/or post-heating) logs 126.

In one embodiment, as logs 126 pass through chamber interior 101, the amounts of transmitted and reflected power are measured by respective detectors 116 and 118 and transmitted to controller 122 via respective signals S1 and S2.

An aspect of the disclose includes employing a drying model that accounts for at least a heat capacitance, a water content and a mass of the green cellular ceramic bodies and that relates a change in the dissipated microwave power to a change in the green cellular ceramic body temperature. To this end, controller 122 is configured (e.g., programmed) to adjust the power of the microwave energy generated by microwave source 112 based on temperature signals ST received from at least one temperature sensor 150 and the drying model, and in response heat logs 126 in chamber interior 101 to the desired temperature T_{D} using microwave radiation. The amount of the reflected microwave energy is at least partially affected by the composition (including the composition of moisture or liquid in the logs) and the geometry of the logs.

Accordingly, when the power of the microwave energy generated by microwave source 112 is adjusted based on the measured power of the reflected microwave energy, such factors as geometry and composition are also taken into consideration. However, it should also be understood that information concerning the composition and geometry of the logs may also be separately input into controller 122 via electrical signals S3 from input device 134 and used to adjust the power of the microwave energy generated. Accordingly, in an example, microwave dryer system 100 is controlled through closed-loop feedback and feed-forward control based on electrical signals S1, S2, ST, S3 and S4 respectively received from transmitted power sensor 116, reflected power sensor 118, at least one temperature sensor 150, input device 134 and detector 154.

Further, as discussed in greater detail below, by monitoring the temperatures of logs 126 (and in particular, the final log temperature T_{F}) via temperature signals ST, controller 112 can be used to adjust the amount of microwave power provided to microwave heating chamber 102. As it turns out, a change of initial log status (i.e., a change in one of the physical parameters defining the log properties, such as weight, size, wetness, etc.), in addition to microwave power, contributes to the variability of the final log temperature T_{F}.

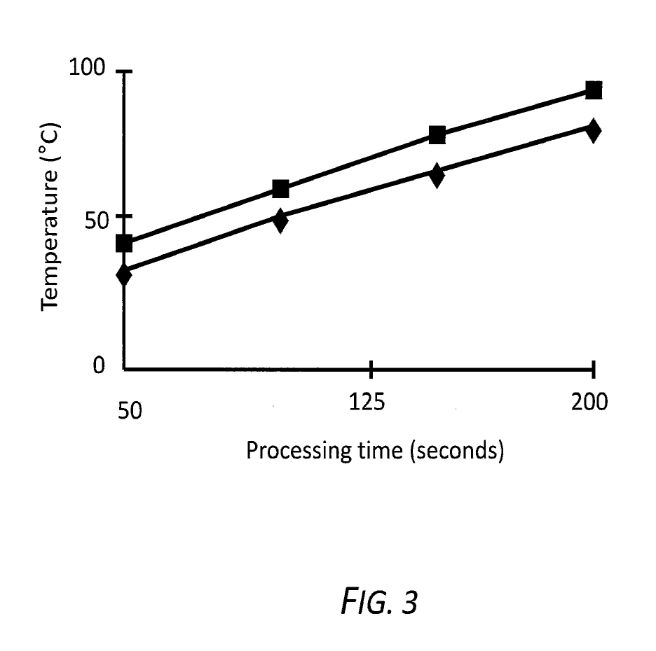

FIG. 3 is a plot of temperature (° C.) vs. processing time (seconds), showing a measured average temperature difference of about 10° C. for a log mass difference of about 9.2% between two logs samples. The log samples were made of EX80 material with a cell structure of 200/12 and size of 10.5″×13″. Sample 1 (plotted as diamonds) was 18.1 lbs and sample 2 (plotted as squares) was 16.3 lbs.

Short-term process variability attendant with the batch and extrusion processes can be minimized by process improvement. Short-term process variability due to changes in tray spacing D_{T} can be reduced by a combination of feed-forward and/or feedback dissipation power control. Embodiments of the present disclosure include adaptive control methods to reduce or eliminate long-term variability in the final log temperature TF caused by, for example, changes in the upstream process that occur over relatively long time scales (e.g., not log to log variations, but rather between batches used in extruder 117 to form the logs) and details of the controller architecture to reduce short-term log to log temperature variability.

Variations in microwave power dissipation have been found to significantly impact the final log temperature T_{F}. As a result, the dissipation power can be used to counteract the impact of long-term variations of final log temperature T_{F}. Such factors include log weight and water content variations brought in by composition changes, upstream process variability, etc.

In example embodiments, initial and intermediate log temperature measurements are used in drying model calculations carried out by controller 122 to reduce short term process variability. For an example microwave dryer system 100 that employs single applicator AP, the initial temperature and the intermediate temperature are the same. In an example where microwave dryer system 100 employs multiple applicators AP₁ . . . APⱼ . . . AP_{M}, the temperature of a log 26 as it enters thet applicator is the intermediate temperature. Such temperature measurements are used as inputs to the drying model to compute the dissipated power needed for a given operating condition, as discussed in detail below.

To control final log temperature variability, the expected initial temperature is accounted in the calculation of C_{dissipated} (see below) for the first applicator, while its variation propagates down through the other applicators and is reflected in final log temperature. The long-term shift in the initial temperature is compensated by system level feedback control, as discussed in detail below.

### Drying Model

Variations in the final log temperature δT can be expressed as:

$$δ T = \frac{t \cdot δ \overline{p}}{{C}_{p \_ dry} ( 1 - {R}_{{H}_{2} O} ) {w}_{k}} \qquad ( Eq . 1 )$$

where t is the total drying time when the log is exposed to microwave radiation, δ p̅ is the averaged shift of (i.e., change in) dissipated microwave power, and δT is the shift (long-term variation) of the final log temperature as caused by the shift of microwave power. The variables Cₚ_{_{—}}_{dry}, R_{H}_{₂}_{O} and wₖ are the undisturbed heat capacitance of a dried log, the log water content (i.e., the water mass fraction versus the log mass), and the log mass, respectively. A slow (i.e., long-term) shift of final log temperature δT_{ob} can be compensated by a power shift given by:

$$δ {\overline{p}}_{ad} = \frac{{C}_{p \_ dry} ( 1 - {R}_{{H}_{2} O} ) {w}_{k}}{t} ( - δ {T}_{ob} ) \qquad ( Eq . 2 )$$

Equation (2) leads to the following expression for the microwave dissipation power control:

$$Δ {C}_{dissipated} = \frac{{C}_{p \_ dry} ( 1 - {R}_{{H}_{2} O} )}{t} ( - δ {T}_{ob} ) \qquad ( Eq . 3 )$$

Consequently, the dissipation power as measured in “per tray inch” is given by:

$$Δ {C}_{dissipated}^{′} = \frac{{C}_{dissipated}^{′}}{{C}_{dissipated}} Δ {C}_{dissipated} \qquad ( Eq . 4 )$$

The normalized tray inch is defined as the ratio of the measured tray inches to the maximum expected tray inches. Equation (3) means that each applicator will have same adjustment. If a different power adjustment is to be implemented, equations (3) and (4) are modified as follows:

$$\begin{matrix}\frac{t}{M} {\sum }_{j = 1}^{M} Δ {C}_{{dissipated}_{j}} = {C}_{p \_ dry} ( 1 - {R}_{{H}_{2} O} ) ( - δ {T}_{ob} ) & ( Eq . 5 ) \\ Δ {C}_{{dissipated}_{j}} = \frac{{C}_{{dissipated}_{j}}^{′}}{{C}_{{dissipated}_{j}}} Δ {C}_{{dissipated}_{j}} & ( Eq . 6 )\end{matrix}$$

Where M is the total number of microwave applicators AP, where C_{dissipated} _{ⱼ} and ΔC_{dissipated}_{ⱼ} are respectively the power control coefficient for jth applicator and its adjustment. To implement this non-equal power adjustment, in one example a rule or method of power distribution that satisfies equation (5) is adopted. In an example, the rule or method is one that provides the most benefit to the drying process (i.e., results in optimal log drying).

### Identification of Long-Term Shifts in Log Temperature

An aspect of the methods disclosed herein involves extracting long-term temperature variation information from the measured log temperatures, which contains both short-term and long-term temperature variations. In an example, the measured temperature is the final log temperature T_{F}.

In an example, statistical process control techniques are applied to extract the long-term temperature variations. To this end, the observed temperature variation δT_{ob} is expressed as follows:

$$δ {T}_{ob} = {T}_{expected} - \frac{1}{N} {\sum }_{ } {T}_{measured} \qquad ( Eq . 7 )$$

Where T_{exp ected} is the expected final log temperature and the term

$$\frac{1}{N} {\sum }_{ } {T}_{measured}$$

is an averaged final measured log temperature, where the average is taken from the last N temperature measurements (i.e., is a moving average).

An example approach to determine whether there has been a process shift in the formation and processing of logs 126 is to use process control charts. A control chart can be created using the measured final log temperatures from the first hours of production. Each data point in the control chart is the average log temperature over a period of time. Once the mean, upper control limits and the lower control limits are determined, the new data (log temperatures) for subsequent hours of production are appended to the existing data base and the process is monitored for any abnormalities.

An example chart suitable for use in carrying out the methods described herein is called an “Individual Controls Chart,” and is also known as an IMR chart. From this chart, a process shift can be determined if 8 or more data points (standard rule) are on the same side of the mean. Once such a situation occurs, an average of the last 8 data points is computed and the difference between this average value and the target log temperature determine the log temperature drift. The control chart method provides a standardized procedure for computing the temperature drift only when there is a process shift. If there is no process shift flagged by the control chart, then the temperature drift calculations need not be performed thereby reducing the controller computation burden.

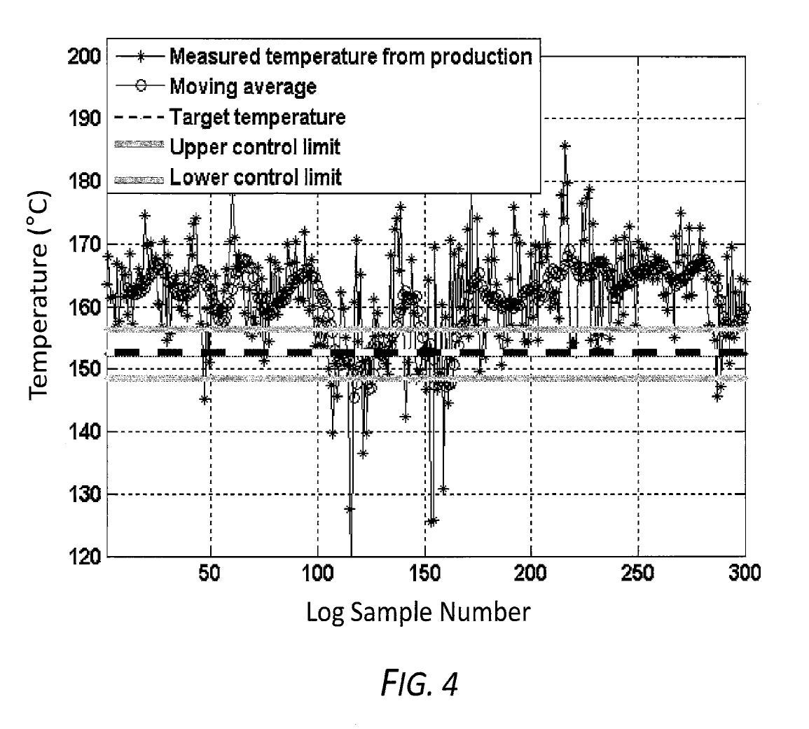

FIG. 4 shows an example chart that plots the measured final log temperature (° C.) versus log sample number, wherein the data in the chart are actual production data. In FIG. 4, the target (desired) final log temperature T_{D}=152.5° C. (central bold dashed line), and the threshold about temperature T_{D} is ±4° C. (thick gray lines on either side of the black dashed line). The circles represent the moving average of 10 sample logs as calculate using equation 7 (above), wherein the asterisks represents actual measured temperatures. The fast-changing measured temperatures illustrated in the chart are likely due to changes in tray spacing D_{T}, which reduces the amount of log mass per tray inch within chamber interior 101.

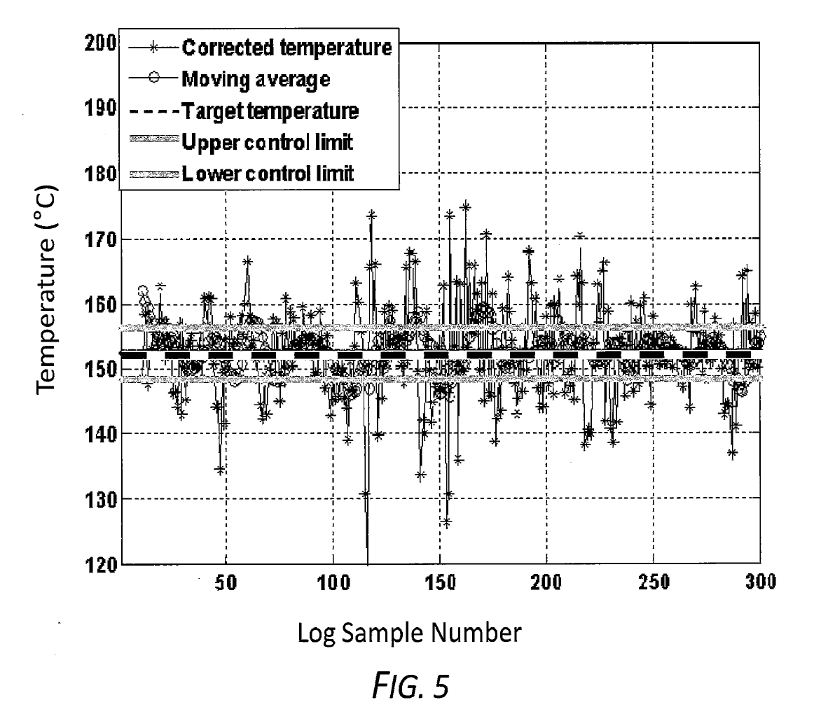

FIG. 5 is similar to FIG. 4 and shows a control chart wherein microwave dryer system 100 utilized long-term temperature shifts as feedback to microwave source 112 to adjust the amount of microwave energy provided to chamber interior 101 based on updates in the required dissipated power provided to controller 112 and using the drying model. Using this temperature-based feedback, the temperature variations are less pronounced and better centered about the target temperature T_{D} as compared to the data of FIG. 4.

### Adjusting Power Coefficients for Multiple Applicators

An aspect of the disclosure is a method of distributing the microwave power by weighting the power control coefficient against a pre-existing power profile. If ΔC_{dissipated} is the power control coefficient required in a microwave dryer system 100 that includes multiple applicators over which is the power correction is distributed, the long-term shift corrected power dissipation coefficient for a given applicator j is given as:

$${C}_{{dissipated}_{j}}^{new} = {C}_{{dissipated}_{j}}^{old} + \frac{{C}_{{dissipated}_{j}}}{{\sum }_{j = 1}^{m} {C}_{{dissipated}_{j}}} Δ {C}_{dissipated} \qquad ( Eq . 14 )$$

where C_{dissipated}_{ⱼ} is the power dissipation coefficient for applicator j before including long-term shifts, and m is the number of applicators used for offsetting the long-term shift.

The method of modifying the power control coefficient can be carried out using a number of different steps. In step 1, record a number N of final log temperatures using temperature sensor 150A. Then, in step 2, using the N final log temperatures, calculate δT_{ob} using equation (7), above. Next, in step 3, compare δT_{ob} to a threshold temperature change δT_{TH}. If δT_{ob}<δT_{TH}, then the method proceeds to step 4 where the next log temperature is recorded. The method then returns to step 2 where δT_{ob} is re-calculated. If δT_{ob}>δT_{TH}, then in step 5, ΔC_{dissipated} is calculated using equation (3), above. Next, in step 6, equations (13) and (14) are used to compute C_{dissipated}^{new} on m applicators AP. If there are more logs 126 to be processed, then the method returns to step 4 of recording the next log temperature, and the method repeats from there. The method terminates after all the logs are processed.

In a modified version of the above-describe method, the number m of the M total applicators AP in which the power adjustment should be made depends on the magnitude of the temperature shift at the end of the drying process. As in the above-described method, if the observed temperature drift δT_{ob} is greater than the temperature drift threshold δT_{TH}, then the power control coefficient is modified in the drying process model to account for this drift. In an example, the temperature drift threshold δT_{TH} can be determined based on the measurement accuracy of temperature sensor 150 and the minimum observable log temperature change from a unit change in microwave power.

Depending on the magnitude of the observed temperature drift δT_{b}, the number m of applicators in which the power control coefficient needs to be modified can be determined. The ratio R of the observed temperature drift to the temperature drift threshold (i.e., R=δT_{ob}/δT_{TH}) determines the number m of the Mtotal applicators AP for which the power control coefficient needs to be modified, with a restriction on the maximum number of applicators.

For example, assume that the temperature drift threshold δT_{TH}=2° C. This means that any log temperature drift less than 2° C. will not incur any change to the power control coefficient. However, if the observed log temperature drift δT_{ob}=7° C., then the number m of applicators in which the power control coefficient would be modified will be equal to

$$m = round ( \frac{7}{2} ) = 4 applicators .$$

The total power control coefficient change is equally distributed among the m=4 applicators.

More generally, if ΔC_{dissipated} is the power control coefficient for a microwave dryer system 100 where the correction can be distributed over m applicators, the long-term-shift corrected power dissipation coefficient for a given applicator j is:

$${C}_{{dissipated}_{j}}^{new} = {C}_{{dissipated}_{j}}^{old} + \frac{Δ {C}_{dissipated}}{m} {\vert}_{m \leq M} \qquad ( Eq . 15 )$$

where C_{dissipated}_{ⱼ} is the power dissipation coefficient for applicator j (before including long-term shifts), and m is the number of applicators used for offsetting the long-term shift, and M is the maximum (total) number of applicators in the dryer.

### Controller Architecture

### Controller Embodiment 1

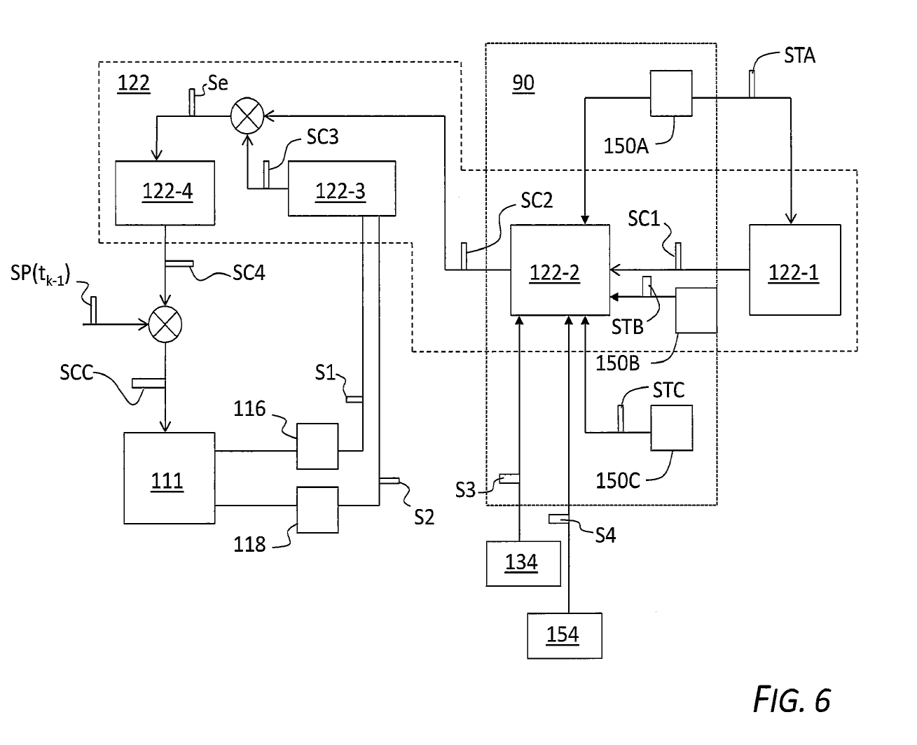

FIG. 6 is a schematic diagram of an example configuration for controller 122 shown in connection with some of the relevant components of microwave dryer system 100. Controller 122 includes a first controller unit 122-1 connected to temperature sensors 150A and is configured to determine (e.g., calculate) long-term shifts in the log temperature T_{L} (e.g., the final log temperature TF) and to generate power adjustment information in the form of control signals SC1. First controller unit 122-1 is thus referred to as the “long term” or “LT” controller unit. LT controller unit 122-1 need only function relatively slowly because it executes the moving average calculation for the temperature variation at a relatively slow rate as the temperature measurements are made on the processed logs.

Controller 122 also includes a second controller unit 122-2 that determines the amount of dissipation power needed (i.e., the expected dissipated power) based on such factors as the initial log dryness, initial log temperature, intermediate log temperature, tray inch, log weight, tray spacing, material properties, etc., and provides this information in the form of a second control signal SC2. The expected dissipated power is obtained by using the drying model described in the above-mentioned '435 publication. Controller unit 122-2 is thus referred to as the “dissipation power” or “DP” controller unit. Note that in some examples, the amount of dissipated power is unrelated to a physical property of the logs, e.g., is a function of the tray spacing.

Controller 122 also includes a third controller unit 122-3 that determines the amount of transient dissipation power based on the information provided by forward and reflected power sensors 116 and 118 as embodied in respective signals S1 and S2, and that provides this information in a third control signal SC3. Controller unit 122-3 is thus referred to as the “transient dissipation power” or “TDP” controller unit.

Controller 122 also includes a fourth controller unit 122-4 in the form of a single-input-single-output (SISO) controller, such as a Proportional-Integral (PI) controller. Fourth controller unit 122-4 is thus referred to as “PI controller unit” 122-4 in this embodiment.

In one mode of operation, control signal SC1 from LT controller unit 122-1 is received by DP control unit 122-2, which then computes the amount of dissipation power needed (i.e., the expected dissipated power) to compensate for the long-term log temperature variability and determines the new drying model parameter as given by Eq. 15. In a second mode of operation, electrical signals S3, S4, STA, STB and STC from devices 143, 154 and temperature sensors 150A, 150B and 150C are received by DP control unit 122-2, which then generates a control signal SC2 representative of the amount of dissipation power needed to compensate for the short-term log temperature variability. These two modes of operation execute at a different time scale, with the latter mode of operation executing much faster than the first. For example, the first mode of operation executes at a 1-2 hour time scale while the second mode of operation executes at 1-2 second time scale.

In the meantime, the TDP control unit 122-3 generates control signal SC3 representative of the amount of transient (measured) dissipated power calculated based on the information in signals S1 and S2, i.e., the measured dissipated power is obtained by computing the difference between the accurately measured forward and reflected power levels.

Control signals SC2 and SC3 are then combined to form an error signal Se representative of the error between the expected dissipated power and the measured dissipated power, and signal Se is provided as the single input to PI controller unit 122-4. PI controller 122-4 then calculates the change in the magnetron power ΔP_{mag} and provides this as an output control signal SC4. Control signal SC4 is combined with an electrical signal SP(tₖ₋₁) representative of a previous control action P(tₖ₋₁) to form a combined control signal SCC that is provided to microwave generator 111.

Combined signal SCC causes microwave generator 111 to change the amount of microwave power it generates based on the value of ΔP_{mag} and the previous control action P(tₖ₋₁), where tₖ₋₁ is the previous time instant. An example of previous control action P(tₖ₋₁) is the previous magnetron power.

The error between the expected dissipated power and the measured dissipated power as embodied in error signal Se is defined as:

$$e = {C}_{dissipated} \cdot {\sum }_{i = 1}^{N} {w}_{i} - ( {P}_{forward} - {P}_{reflected} ) \qquad ( Eq . 8 )$$

which is a function of both the expected and measured dissipated powers. This expression can also be set forth as:

e=C′_{dissipated}×tray_inch−(P_{forward}−P_{reflected}) (Eq. 9)

The output of PI controller unit 122-4 (described in “Velocity” form) as embodied in control signal SC4 is the change in the magnetron power ΔP_{mag} and is given as follows:

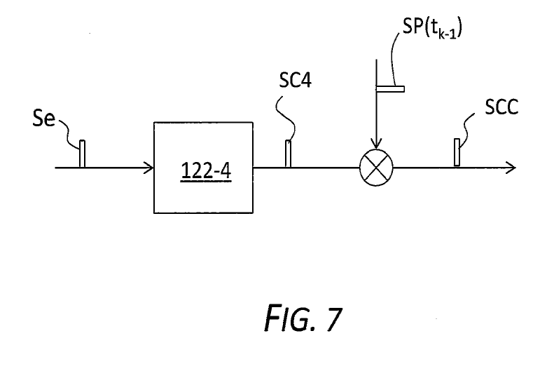

ΔP_{mag}=K₁·Δe(t)+K₂·e(t) (Eq. 10)

where K₁ and K₂ are the parameters of the PI controller unit. FIG. 7 is a schematic diagram of an example controller configuration for this first embodiment. Note that output of PI controller unit 122-4 is only the change in the magnetron power ΔP_{mag} required to minimize the error between the expected dissipated power and the measured dissipated power. The PI controller output signal SC4 is added to signal SP(tₖ₋₁) representative of previous control action P(tₖ₋₁) to obtain the combined control signal SCC, which is representative of the final magnetron power. However, in this embodiment the rate at which the magnetron power is changed (also referred to as the power ramp rate) is pre-determined and maintained at a constant value.

### Controller Embodiment 2

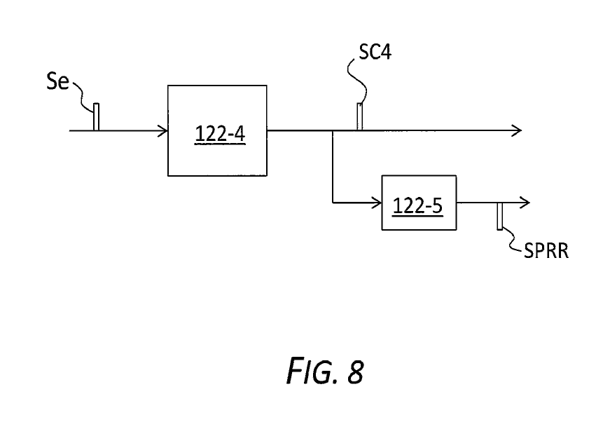

A second example configuration for controller 122 has a single input and multiple outputs (SIMO), e.g., two outputs. FIG. 8 is a schematic diagram of the SIMO controller configuration formed using PI controller unit 122-4 and an additional controller unit 122-5 used to calculate the power ramp rate PRR using equation (11), below (controller 122-5 is thus referred to as the “PRR controller unit”). As with the first example controller configuration, the input to PI controller 122-4 is error signal Se representative of the error between the expected dissipated power and the measured dissipated power. The outputs are the change in the magnetron power ΔP_{mag} as embodied in control signal SC4 and the power ramp rate PRR as provided by PRR controller unit 122-5 in the form of an electrical signal SPRR.

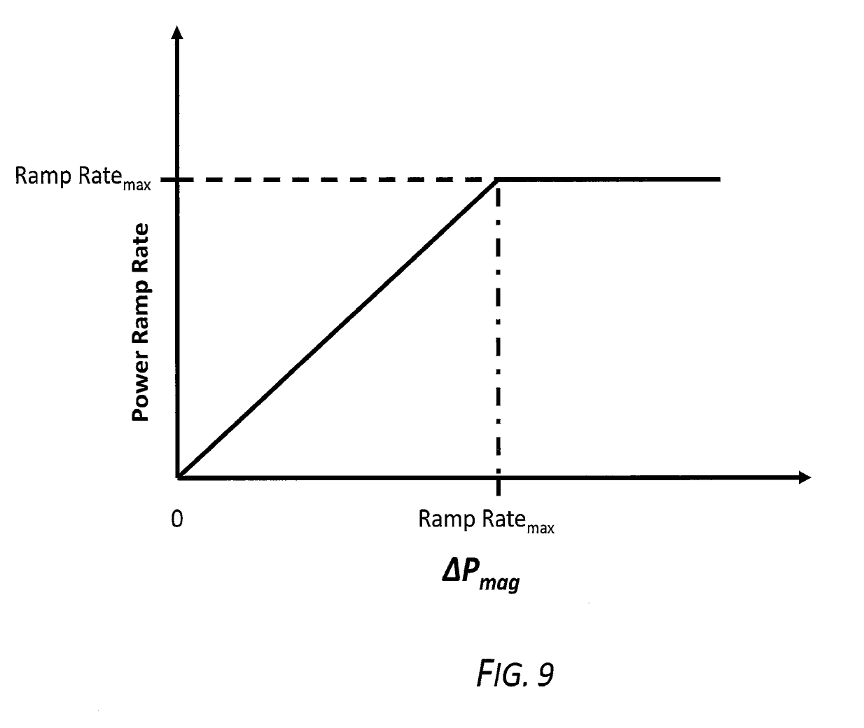

The change in the magnetron power ΔP_{mag} is as described in either equation (10) above or equation (14) below, and the power ramp rate PRR is given as follows:

$$PRR = \{ \begin{matrix}{K}_{3} Δ {P}_{mag} & Δ {P}_{mag} < ( Ramp {Rate}_{max} ) ( 1 sec ) \\ Ramp {Rate}_{max} & Δ {P}_{mag} \geq ( Ramp {Rate}_{max} ) ( 1 sec )\end{matrix} \qquad ( Eq . 11 )$$

where Ramp Rateₘₐₓ is the maximum rate in (KW/sec) at which the magnetron is capable of changing the power, and K₃ is a parameter that satisfies the condition, 0<K₃≦1. FIG. 9 sets a plot of equation (11) of power ramp rate as a function of the change in magnetron power ΔP_{mag}, with K₃=1.

An advantage of using Controller Embodiment 2 over Controller Embodiment 1 is that in Controller Embodiment 2, the power ramp rate PRR is a function of the change in magnetron power as determined by the PI controller 122-4, as opposed to a pre-determined fixed value of Controller Embodiment 1.

For example, in Controller Embodiment 1, if the power ramp rate PRR is set to a very low value and ΔP_{mag} is very large, then the time taken for the magnetron to make the change in the power is very large. This large delay in the system response could potentially result in certain logs not seeing the effect of the new control action since logs are continuously moving on a conveyor belt, so that certain logs could have already left the applicator before the magnetron power for that applicator reaches the new output value. On the other hand, if the power ramp rate PRR is set to a very large value, it could be detrimental to the life of the magnetron. In Controller Embodiment 2, the power ramp rate is determined by the additional power required as determined by the value of ΔP_{mag} as computed by the controller, thereby influencing the system response time and also protecting the life of the magnetron.

Deciding whether to implement Controller Embodiment 1 or Controller Embodiment 2 should be based mainly on the manufacturer specifications of the microwave applicator. In applicators where the power ramp rate PRR can be adjusted electronically, Controller Embodiment 2 may be used effectively, and in applicators where the power ramp rate cannot be adjusted online and is set to a pre-determined fixed value, Controller Embodiment 1 may be used effectively.

### Controller Embodiment 3

A third example configuration for controller 122 has two inputs and two outputs, i.e., is a multiple-input/multiple-output (MIMO) controller. The outputs are similar to the ones described in Controller Embodiment 2, namely, the combined control signal SCC and the power ramp rate PRR. However, the inputs to the controller are the error between the expected dissipated power and the measured dissipated power as represented by error signal Se, and the tray inch as embodied in an electrical signal S4, which provides an estimate of the load inside a particular applicator.

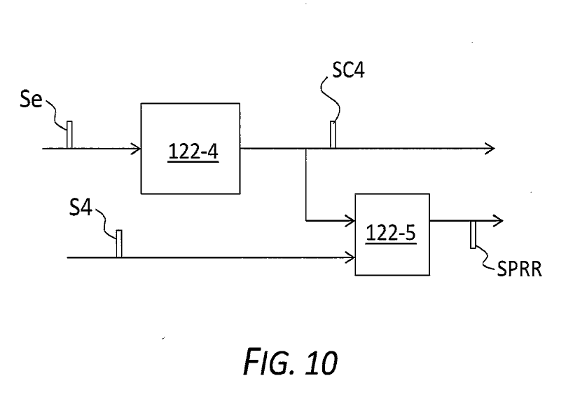

FIG. 10 is a schematic diagram of an example MIMO controller configuration similar to that of FIG. 8, except that PRR controller unit 122-5 receives tray inch signal S4 from the detector 154, for example (see FIG. 2). The change in the magnetron power ΔP_{mag} is obtained as described in either equation (10) or equation (14) and the power ramp rate PRR is determined in PRR controller unit 122-5 using the following relationship using the information in tray inch signal S4:

$$PRR = \{ \begin{matrix}Φ ( tray\_inch , Δ {P}_{mag} ) & Δ {P}_{mag} < ( Ramp {Rate}_{max} ) ( 1 sec ) \\ Ramp {Rate}_{max} & Δ {P}_{mag} \geq ( Ramp {Rate}_{max} ) ( 1 sec )\end{matrix} \qquad ( Eq . 12 )$$

where Φ(.) is a nonlinear function. One method of determining Φ(.) is to approximate it with a look-up table. Plotting Φ(.) as a function of the normalized tray inch and the normalized change in magnetron power ΔP_{mag} yields a surface of the look-up table space. As discussed above, the normalized tray inch is defined as the ratio of the measured tray inches to the maximum expected tray inches. The normalized change in the magnetron power and the normalized power ramp rate is obtained by dividing the change in the magnetron power and the power ramp rate by the maximum rate at which the magnetron can change the power.

An advantage of using Controller Embodiment 3 over Controller Embodiment 2 is that the power ramp rate is a function of both the change in the magnetron power and the applicator load. This further enables microwave dryer system 100 to respond with sufficient speed to affect the logs before they exit the applicator.

### Controller Embodiment 4

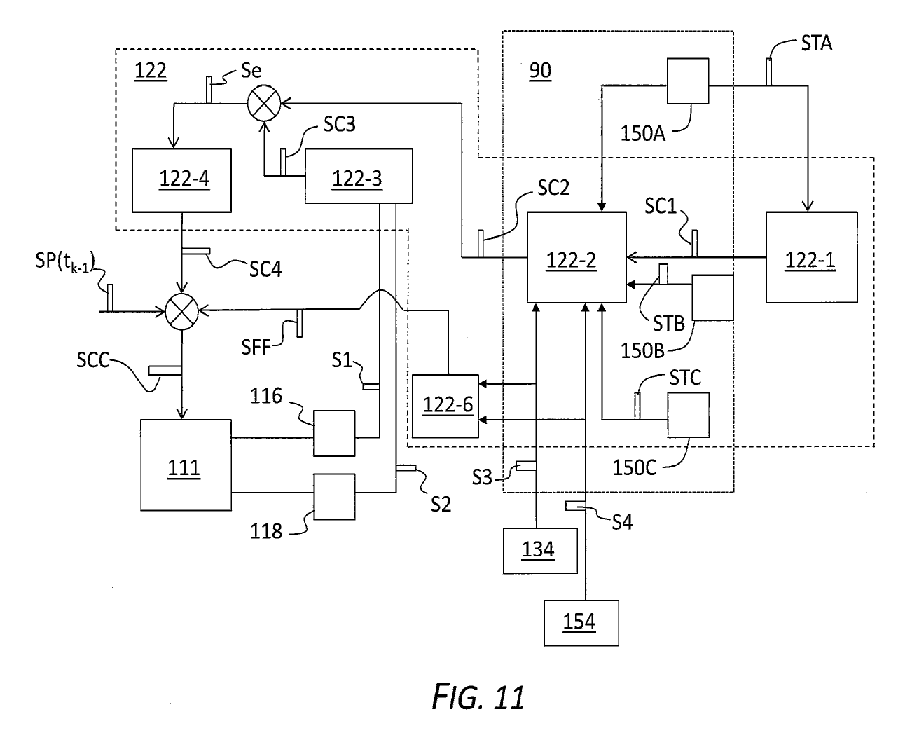

FIG. 11 is similar to FIG. 6 and illustrates an example microwave dryer system 100 based on a feed-forward controller configuration used in conjunction with feedback control. Controller 122 includes a feed-forward (FF) controller 122-6. The inputs to FF controller 122-6 include one or more process changes, such as changes in tray spacing D_{T} inferred from tray inch count measurements, signal S4 from detector 154 and the log weight, signal S3 from input device 134, that affect the log drying process. The output of the FF controller 122-6 is a feed-forward signal SFF representative of the reference power required to counteract the effect of the one or more process changes. This reference power is then added to the change in the magnetron power ΔP_{mag} computed by PI controller 122-4 (and embodied in control signal SC4) to obtain the final total power of the microwave generator (magnetron) 111.

In this embodiment, since the magnetron power P is computed using information from FF controller 122-6, the structure of the feedback controller also changes. In general, the structure of the feed-forward controller 122-6, is given as follows:

P_{ref}=Ψ(D₁, D₂, . . . ) (Eq. 13)

where P_{ref} is the magnetron reference power, D1, D2, . . . are the measured changes (changes) affecting the drying process, and the function Ψ(.) is a nonlinear function. In an example, the function Ψ(.) is associated with a fuzzy logic-based controller, such as described in the '667 publication, in which the tray spacings inferred from the tray inch count measurement and the log weight are the measured changes.

The equation describing the operation of feedback controller 122-4 is given as follows (Eq. 14):

$$Δ {P}_{mag} = {K}_{1} \cdot e ( t ) + {K}_{2} {\int }_{0}^{t} e ( t ) d t$$

where K₁ and K₂ are the controller parameters. Note the difference in the representation of the feedback controller 122-4 as described in this embodiment as compared to Controller Embodiment 1. The difference is primarily due to the way the reference power P_{ref} is obtained. The power ramp rate could also be another output of the feedback control and depending on the application the equation describing the power ramp rate PRR could be one of the two equations described in Controller Embodiments 2 and 3.

The combined feed-forward plus feedback control can significantly enhance the performance of the control scheme as compared to a simple feedback control system whenever there is major process change that can be measured before it substantially affects the drying process. The feedback control system is a reactive control that responds in a situation where the drying process has already undergone a substantial change. However, if such a process change could be anticipated and if corrective action can be taken to avoid the change in the microwave system performance, the microwave dryer system performance would be enhanced.

In this embodiment 4, FF controller unit 122-6 computes the amount of microwave power required to counteract the effect of one or more process changes (e.g., tray spacing gaps inferred from tray inch count measurements and log weight). However, there may exist changes to the process that are not readily explained or measured. The feedback control, in addition to tracking the set-point changes (i.e., minimizing the error between expected dissipated power and measured dissipated power), also minimizes the effect of the unmeasured changes on the process.

Another advantage of using feed-forward control to compute the reference power P_{ref} is to ensure that the drying process does not drift and become unstable. Recall, output signal SC4 from the PI controller unit 122-4 represents the change in the magnetron power ΔP_{mag} from the previous value. This could potentially lead to an accumulation of errors from past control actions, thereby causing instability in the drying process. By having the reference power P_{ref} computed by FF controller unit 122-6, unchecked process drift is prevented by adding the change in the magnetron power ΔP_{mag} to the calculated reference power P_{ref}, thereby maintaining system stability.

The methods, microwave dryers and systems described herein are particularly suitable for heating, and thereby drying, ceramic green bodies (logs). Drying, as used herein, refers to a reduction in the liquid content of the log to a desired value. The heating and drying of the logs is carried out to a degree where the log can be mechanically handled without causing any damage thereto or unacceptable deformation thereof. For example, logs of the cylindrical body type, such as cylindrical logs having a cellular structure exhibiting a cell density from about 100 to about 1600 cells/in², are sufficiently dry for mechanical handling purposes when the log has less than about 5% of its original moisture content. In another embodiment, the logs are sufficiently dry for mechanical handling purposes when the log has less than about 1% of its original moisture content.

It will be apparent to those skilled in the art that various modifications and variations can be made to the present disclosure without departing from the spirit and scope of the disclosure. Thus it is intended that the present disclosure cover the modifications and variations of this disclosure provided they come within the scope of the appended claims and their equivalents.

What is claimed is:

1. A control method of microwave drying green cellular ceramic bodies using an adjustable microwave source operably coupled to a microwave chamber, comprising:
passing the green cellular ceramic bodies through the microwave chamber to expose them to microwave radiation having a microwave power generated by the microwave source;
periodically measuring an amount of dissipated microwave power and generating first signals representative thereof;
periodically measuring temperatures of the green cellular ceramic bodies and generating second signals representative thereof;
inputting the first and second signals into a drying model that accounts for at least a heat capacitance, a water content and a mass of the green cellular ceramic bodies, and that relates a change in the dissipated microwave power to a change in the green cellular ceramic body temperature;
using the drying model, calculating a change in the amount of dissipated power due to changes in the green cellular ceramic bodies based on the measured temperature changes and the measured dissipated microwave power; and
adjusting the amount of microwave power generated by the adjustable microwave source by the calculated amount of dissipated power.

2. The method of claim 1, wherein a portion of the measured dissipated microwave power is unrelated to a physical property of the green cellular ceramic bodies.

3. The method of claim 1, wherein the measured temperatures constitute final temperatures of dried green cellular ceramic bodies.

4. The method of claim 1, wherein the measured temperatures constitute initial and intermediate temperatures of green cellular ceramic bodies while they undergo drying.

5. The method of claim 3, further comprising performing said adjusting of the amount of microwave power to maintain the final temperatures at or about a select final temperature.

6. The method of claim 1, wherein the microwave chamber comprises one or more applicators.

7. The method of claim 1, wherein performing said adjusting of the amount of microwave power is based on an amount of dissipated microwave power per unit mass of material making up the green cellular ceramic bodies.

8. The method of claim 1, wherein performing said adjusting of the amount of microwave power is performed to maintain the measured amount of dissipated microwave power between upper and lower power thresholds based on a type and a quantity of the green cellular ceramic bodies.

9. The method of claim 1, further comprising:
forming the green cellular ceramic bodies using a process having a plurality of process parameters; and
adjusting at least one of the plurality of process parameters to maintain the measured temperature to within a threshold value of a select temperature.

10. The method of claim 1, wherein the microwave chamber has an exit and further comprising performing the measuring of temperatures using a temperature sensor arranged proximate the exit.

11. A microwave drying system with a feedback and feed forward control for drying green cellular ceramic bodies, comprising:
a microwave chamber having an interior through which the green cellular ceramic bodies are conveyed from an entrance to an exit;
an adjustable microwave source operably coupled to the microwave chamber and configured to generate microwave radiation having an amount of microwave power within the microwave interior;
first and second detectors respectively arranged to measure transmitted and reflected microwave power and generate respective first and second signals representative thereof;
at least one temperature sensor arranged to periodically measure temperatures of the green cellular ceramic bodies and generate third signals representative thereof; and
a programmable controller configured with a drying model that performs a calculation of a change in the amount of dissipated power due to changes in the temperature of the green cellular ceramic bodies based on the measured temperature changes and the measured dissipated microwave power, wherein the drying model accounts for at least a heat capacitance, a water content and a mass of the green cellular ceramic bodies, the controller further configured to provide a control signal to the microwave source to adjust the amount of microwave power provided to the microwave cavity based on the calculated change in the amount of dissipated power.

12. The system of claim 11, wherein the at least one temperature sensor measures temperatures at an end of a microwave drying process so that the measured temperatures constitute final temperatures of the dried green cellular ceramic bodies.

13. The system of claim 11, wherein the at least one temperature sensor measures temperatures at the inlet of a microwave drying process so that the measured temperatures constitute initial temperatures of the green cellular ceramic bodies.

14. The system of claim 11, wherein the at least one temperature sensor includes an intermediate temperature sensor that measures intermediate temperatures of the green cellular ceramic bodies.

15. The system of claim 11, wherein the microwave chamber comprises a plurality of applicators.

16. The system of claim 11, wherein the controller comprises a computer and includes instructions embodied in a computer-readable medium that cause the computer to perform said calculation and generate said control signal.

17. A control method of drying green cellular ceramic bodies in a drying process, the method comprising:
conveying the green cellular ceramic bodies through a microwave chamber having an interior and an exit;
providing an amount of microwave power to the microwave chamber interior;
measuring an amount of microwave power dissipated by the microwave chamber interior and the green cellular ceramic bodies conveyed therethrough;
measuring initial temperatures of the green cellular ceramic bodies during the drying process;
measuring final temperatures of the green cellular ceramic bodies at or adjacent the exit at an end of the drying process; and
adjusting the amount of microwave power provided to the chamber based on a drying model for the green cellular ceramic bodies that accounts for at least a heat capacitance, a water content and a mass of the green cellular ceramic bodies, and that relates a change in the measured dissipated microwave power to a change in the green cellular ceramic body temperature as determined from the measured final temperatures.

18. The control method of claim 17, further comprising measuring intermediate temperatures during the drying process to determine an intermediate amount of heating of the green cellular ceramic bodies during the drying process and inputting the intermediate temperatures into the drying model.

19. The control method of claim 17, further comprising providing the amount of microwave power to the microwave chamber interior using a plurality of applicators.

20. The control method of claim 17, further comprising:
forming the green cellular ceramic bodies using a process having a plurality of process parameters; and
adjusting at least one of the plurality of process parameters to maintain the measured final temperature to within a threshold value of a select final temperature.
